(19) United States
(12) Patent Application Publication
(10) Pub. No.: US 2026/0011032 A1
(43) Pub. Date: Jan. 8, 2026

(54) METHOD AND SYSTEM FOR PROVIDING SPATIO-TEMPORAL PRESERVATION TRANSFORMER FOR THREE-DIMENSIONAL HUMAN POSE AND SHAPE ESTIMATION

(71) Applicant: LG MANAGEMENT DEVELOPMENT INSTITUTE CO., LTD., Seoul (KR)

(72) Inventors: Min Soo LEE, Seoul (KR); Hyun Min LEE, Seoul (KR)

(21) Appl. No.: 19/324,069

(22) Filed: Sep. 9, 2025

Related U.S. Application Data
(63) Continuation of application No. PCT/KR2024/003120, filed on Mar. 11, 2024.

(30) Foreign Application Priority Data
Mar. 9, 2023 (KR) 10-2023-0030862

(51) Int. Cl. G06T 7/73; G06T 3/02; G06T 3/14; G06T 7/33; G06T 7/55; G06T 13/40; G06T 17/00; G06T 19/00

(52) U.S. Cl. CPC G06T 7/74; G06T 3/02; G06T 3/14; G06T 7/337; G06T 7/55; G06T 7/75; G06T 13/40; G06T 17/00; G06T 19/00; G06T 2207/10016; G06T 2207/20081; G06T 2207/20084; G06T 2207/30196; G06T 2210/16

(57) ABSTRACT

A method and system for providing a spatio-temporal preservation transformer for 3D human pose and shape estimation may provide a transformer that considers both spatial and temporal dimensions and minimizes computational complexity when estimating a 3D human pose and shape based on an image sequence such as a video, thereby improving the data processing efficiency and performance required for the 3D human pose and shape estimation based on the image sequence, enhancing the quality of the resulting data and improving various application services and related industrial environments.

### BACKGROUND

### Field

The present disclosure generally relates to a method and system for providing a spatio-temporal preservation transformer for 3D human pose and shape estimation. More particularly, some embodiments of the present disclosure relate to a method and system for providing a transformer that considers both spatial and temporal dimensions and reduces or minimizes computational complexity, when estimating a 3D human pose and shape based on an image sequence, such as a video.

### Description of Related Art

3D human pose and shape estimation may be an operation for reconstructing a mesh of a person from an image and/or a video.

Research on recognizing and inferring human poses and actions from the input image and video have been developed and can be applied to a wide range of industries, including computer graphics and/or healthcare.

In particular, since the introduction of a Skinned Multi-Person Linear (SMPL) model, which represents 3D human pose and shape based on parameters, the field of 3D human pose and shape estimation has advanced toward predicting SMPL parameters, leading to improvement in performance.

However, single-frame-based 3D human pose and shape estimation is vulnerable to motion blur or occlusion, leading to unstable prediction performance along a temporal axis when estimating from image sequences.

To address this issue, various image sequence-based approaches have been proposed.

For example, recent image sequence-based studies extract features individually from each frame and then combine them to construct a temporal-aware feature in order to directly extend along the temporal axis.

While such extension has contributed to reducing temporal errors, it has the limitation of significantly increasing reconstruction errors.

This is because spatial Information is compressed using global average pooling to address the excessive complexity of spatio-temporal attention and then a temporal relationship is modeled.

Therefore, there is a need for a novel framework for 3D human pose and shape estimation that accounts for both spatial and temporal dimensions without excessively increasing computational complexity.

### SUMMARY

According to some embodiments of the present disclosure, a method and system for providing a transformer may consider both spatial and temporal dimensions and reduce or minimize computational complexity when estimating a 3D human pose and shape based on an image sequence, such as a video.

According to certain embodiments of the present disclosure, a method and system for providing a transformer may consider error uncertainty within the image sequence.

However, the technical objectives to be solved by various embodiments of the present disclosure are not limited to the above-mentioned objectives, and other technical objectives may also exist.

In an aspect, there is provided a method for providing a spatio-temporal preservation transformer for 3D human pose and shape estimation. A computing system including a memory and a processor performs the method for providing the spatio-temporal preservation transformer for 3D human pose and shape estimation, the method including steps of acquiring a predetermined image sequence, acquiring a feature sequence, which is a set of features corresponding to each of a plurality of frames in the acquired image sequence, spatially aligning the acquired feature sequence to the feature of a first frame within the plurality of frames, acquiring spatio-temporal relationship modeling data, which is data modeling spatio-temporal correlation between the plurality of frames, based on a feature spatial alignment sequence, which is the aligned feature sequence, acquiring 3D pose and shape information of an object in the image sequence based on the acquired spatio-temporal relationship modeling data, and providing the acquired 3D pose and shape information. In another aspect, the feature sequence maintains spatial Information and temporal Information without applying pooling to the feature sequence.

In another aspect, the step of acquiring the feature sequence includes steps of detecting a bounding box including an object in the image sequence, and extracting the feature sequence from an image including a detected bounding box region.

In another aspect, the step of spatially aligning the feature sequence includes a step of performing a warping transformation to spatially align features of the remaining frames with the feature of the first frame included in the feature sequence.

In another aspect, the step of performing the warping transformation includes steps of predicting an affine transformation matrix based on the feature of the first frame and the features of the remaining frames, and performing the warping transformation based on the predicted affine transformation matrix.

In another aspect, the step of acquiring the spatio-temporal relationship modeling data includes a step of acquiring the spatio-temporal relationship modeling data based on an attention weight derived from a self attention mechanism according to a transformer architecture.

In another aspect, the step of acquiring the spatio-temporal relationship modeling data further includes a step of performing the self attention based on a batch of a predetermined spatial dimension based on the feature spatial alignment sequence.

In another aspect, the step of acquiring the spatio-temporal relationship modeling data further includes a step of performing multi-head self attention that performs the self attention multiple times in parallel.

In another aspect, the step of acquiring the spatio-temporal relationship modeling data further includes steps of generating an artificial artifact synthesized by randomly replacing at least a portion of the spatial dimension batch with a noise patch at a spatial-temporal location according to another predetermined image sequence, and training a small-scale network to identify the generated artificial artifact.

In another aspect, the step of acquiring the spatio-temporal relationship modeling data further includes a step of generating an uncertainty map, which is a feature map for adjusting the attention weight based on the learned small-scale network.

In another aspect, the step of acquiring the spatio-temporal relationship modeling data further includes a step of adjusting the attention weight of the spatio-temporal relationship modeling data based on the generated uncertainty map.

In another aspect, the step of acquiring the 3D pose and shape information includes a step of predicting pose parameters and shape parameters for the object based on a skinned multi-person linear model (SMPL).

In another aspect, the step of acquiring the 3D pose and shape information further includes a step of predicting the pose parameters and shape parameters by applying the attention weight adjusted based on the uncertainty map.

In an aspect, a system for providing a spatio-temporal preservation transformer for 3D human pose and shape estimation includes memory configured to store instructions that are executable, and at least one processor configured to execute the instructions to provide the spatio-temporal preservation transformer for 3D human pose and shape estimation. The instructions includes acquiring a predetermined image sequence, acquiring a feature sequence, which is a set of features corresponding to each of a plurality of frames in the acquired image sequence, spatially aligning the acquired feature sequence to the feature of a frame within the plurality of frames, acquiring spatio-temporal relationship modeling data, which is data modeling spatio-temporal correlation between the plurality of frames, based on a feature spatial alignment sequence, which is the aligned feature sequence, acquiring information about a 3D pose and shape of an object in the image sequence based on the acquired spatio-temporal relationship modeling data, and providing the acquired information about the 3D pose and shape.

In an aspect, a computing device includes at least one spatial alignment module, at least one space2batch module, at least one uncertainty-guided attention re-weighting module, and at least one processor. The processor acquires a predetermined image sequence, acquires a feature sequence, which is a set of features corresponding to each of a plurality of frames in the acquired image sequence, controls the spatial alignment module to spatially align the acquired feature sequence to the feature of a first frame within the plurality of frames, controls the space2batch module to acquire spatio-temporal relationship modeling data, which is data modeling spatio-temporal correlation between the plurality of frames, based on the aligned feature sequence, acquires information about a 3D pose and shape of an object in the image sequence based on the acquired spatio-temporal relationship modeling data, and provides the acquired the information about the 3D pose and shape.

In another aspect, the processor controls the uncertainty-guided attention re-weighting module to adjust the attention weight of the spatio-temporal relationship modeling data.

A method and system for providing a spatio-temporal preservation transformer for 3D human pose and shape estimation according to an embodiment of the present disclosure may provide a transformer that considers both spatial and temporal dimensions and reduces or minimizes computational complexity, when estimating a 3D human pose and shape based on an image sequence, such as a video, thereby improving the data processing efficiency and performance required for the 3D human pose and shape estimation based on the image sequence, enhancing the quality of the resulting data itself and directly improving various application services and related industrial environments that utilize it.

Further, a method and system for providing a spatio-temporal preservation transformer for 3D human pose and shape estimation according to an embodiment of the present disclosure may provide a transformer that considers error uncertainty within an image sequence, thereby estimating the 3D human pose and shape from the image sequence with high accuracy, even when a certain frame in the corresponding image sequence contains errors such as motion blur and/or occlusion.

Additionally, a method and system for providing a spatio-temporal preservation transformer for 3D human pose and shape estimation according to an embodiment of the present disclosure can easily identify a region where assistance from a surrounding frame (i.e., adjacent frame) is needed when predicting the 3D human pose and shape for a current frame (i.e., central frame), and can prevent the propagation of errors from a specific frame to other frames in advance.

However, the effects obtainable through various embodiments of the disclosure are not limited to the effects mentioned above, and other effects not mentioned may be clearly understood from the following description.

### BRIEF DESCRIPTION OF DRAWINGS

FIG. 1 illustrates a block diagram of a computing system for implementing a service for providing a spatio-temporal preservation transformer according to an embodiment of the present disclosure.

FIG. 2 illustrates a block diagram of a computing device for implementing a service for providing a spatio-temporal preservation transformer according to an embodiment of the present disclosure.

FIG. 3 illustrates a block diagram of a computing device implementing a service for providing a spatio-temporal preservation transformer according to an embodiment of the present disclosure.

FIG. 4 illustrates a block diagram of an uncertainty-based spatio-temporal transformer according to an embodiment of the present disclosure.

FIG. 5 is a flowchart for illustrating a method for providing a spatio-temporal preservation transformer for 3D human pose and shape estimation according to an embodiment of the present disclosure.

FIG. 6 illustrates a conceptual diagram for illustrating a method for providing a spatio-temporal preservation transformer for 3D human pose and shape estimation according to an embodiment of the present disclosure.

FIG. 7 illustrates a conceptual diagram for illustrating a learning method of an uncertainty-guided attention re-weighting module according to an embodiment of the present disclosure.

FIG. 8 illustrates an example of visualizing a data processing method for a service for providing a spatio-temporal preservation transformer according to an embodiment of the present disclosure.

FIG. 9 illustrates a conceptual diagram for illustrating an SMPL for 3D human pose and shape estimation according to an embodiment of the present disclosure.

FIGS. 10 and 11 illustrate examples of comparing performance differences between a methodology for estimating 3D human pose and shape based on an image sequence according to an embodiment of the present disclosure and a conventional methodology.

### DETAILED DESCRIPTIONS

Since the present disclosure may include various modifications and may have various embodiments, specific embodiments will be illustrated in the drawings and described in detail in the detailed description. The effects and features of the present disclosure and methods of achieving them will become apparent with reference to the embodiments described in detail below together with the drawings. However, the present disclosure is not limited to the embodiments as disclosed below, but may be implemented in various forms. In the following embodiments, terms such as first, second, and the like are used for the purpose of distinguishing one component from another component, rather than having a limited meaning. In addition, a singular expression includes a plural expression unless the context clearly indicates otherwise. In addition, terms such as “include” or “have” mean that features or components described herein exist, and do not preclude the possibility that one or more other features or components are added. In addition, in the drawings, the size of each of the components may be exaggerated or reduced for convenience of illustration. For example, the size and thickness of each component shown in the drawings are arbitrarily shown for convenience of illustration, and thus the present disclosure is not necessarily limited to the illustration.

Hereinafter, embodiments of the present disclosure will be described in detail with reference to the accompanying drawings, and the same or corresponding components will be given the same reference numerals when being described with reference to the drawings, and redundant descriptions thereof will be omitted.

### [Exemplary Embodiments of System for Providing a Service for Providing a Spatio-Temporal Preservation Transformer]

Hereinafter, exemplary embodiments of a system for implementing a service for providing a spatio-temporal preservation transformer that considers both spatial and temporal dimensions and reduce or minimizes computational complexity, when estimating a 3D human pose and shape based on an image sequence, such as a video, will be described in detail with reference to the accompanying drawings.

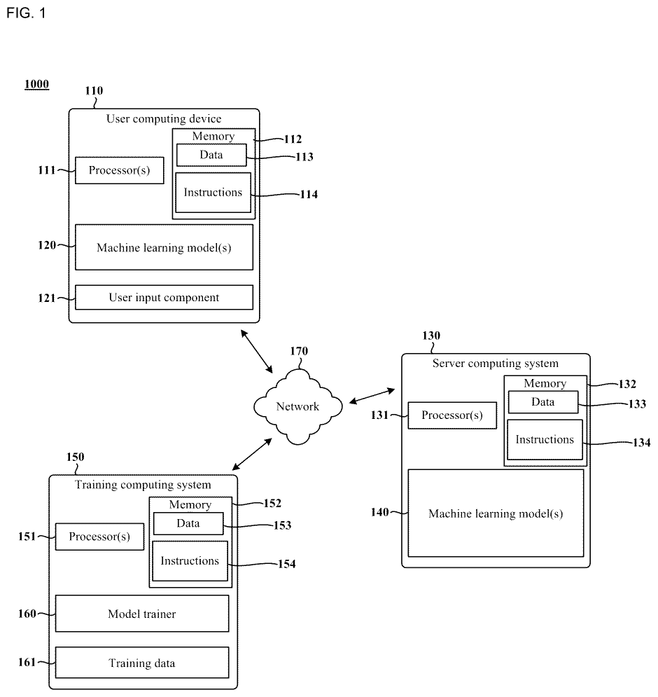

FIG. 1 illustrates a block diagram of a computing system or a computer system for implementing a service for providing a spatio-temporal preservation transformer according to an embodiment of the present disclosure.

Referring to FIG. 1, a computing system or a computer system 1000 for implementing a service for providing a spatio-temporal preservation transformer according to an embodiment of the present disclosure includes a user computing device or a user computer device 110, a server computing system or a server computer system 130, and a training computing system or a training computer system 150. And, one or more of these devices or systems may communicate via a network 170.

A method for providing a spatio-temporal preservation transformer for 3D human pose and shape estimation according to an embodiment of the present disclosure may be implemented and provided in the following ways: 1) the user computing device 110 may locally implement and perform the method, 2) the server computing system 130 communicationally connected with the user computing device 110 may implement and perform the method in the form of a web service, and 3) the user computing device 110 and the server computing system 130 may implement and perform the method in conjunction with each other.

In an embodiment, the user computing device 110 and/or the server computing system 130 may train a machine learning model 120 and/or 140 through interaction with the training computing system 150 that is communicatively connected via a network 170. The training computing system 150 may be a system separate from the server computing system 130 or may be a part of the server computing system 130.

An artificial intelligence model may be 1) trained directly by the user computing device 110 locally, 2) trained through interaction between the server computing system 130 and the user computing device 110 via the network 170, and 3) trained by the training computing system 150 using various training and learning techniques. Further, the artificial intelligence model trained by the training computing system 150 may be provided or updated by being transmitted to the user computing device 110 and/or the server computing system 130 via the network 170.

In some embodiments, the training computing system 150 may be a part of the server computing system 130 or a part of the user computing device 110.

The user computing device 110 may include any type of computing devices or computers, such as a smart phone, a mobile phone, a digital broadcasting device, personal digital assistants (PDA), a portable multimedia player (PMP), a desktop, a wearable device, an embedded computing device, and/or a tablet personal computer (PC).

The user computing device 110 includes at least one processor 111 and a memory 112. The processor 111 may include at least one of a central processing unit (CPU), a graphic processing unit (GPU), application specific integrated circuits (ASICs), digital signal processors (DSPs), digital signal processing devices (DSPDs), programmable logic devices (PLDs), field programmable gate arrays (FPGAs), controllers, micro-controllers, microprocessors, and/or other types of electrical units for performing functions, or a plurality of electrically or communicationally connected processors.

The memory 112 may include one or more non-transitory and/or transitory computer readable storage media such as RAM, ROM, EEPROM, EPROM, flash memory devices, magnetic disks, etc., and combination thereof, and may include web storage of a server that performs the storage function of the memory on the Internet. The memory 112 may store data 113 and instructions 114 which can be retrieved or executed by the processor 111 to perform functions or operations such as training an artificial intelligence model or estimating the 3D human pose and shape through the artificial intelligence model.

In an embodiment, the user computing device 110 may perform at least one machine learning model 120.

In detail, the machine learning model 120 may include or use various machine learning models such as multiple neural networks (e.g., deep neural networks) or other types of machine learning models including non-linear models and/or linear models, or combination thereof.

The neural network may include, for example, but not limited to, at least one of feed-forward neural networks, recurrent neural networks (e.g., long short-term memory recurrent neural networks), convolution neural networks, and/or other types of neural networks.

In an embodiment, the user computing device 110 may receive at least one machine learning model 120 from the server computing system 130 via the network 170, store the received machine learning model 120 in the memory 112, and then execute the stored machine learning model 120 by the processor 111 to perform 3D human pose and shape estimation, etc.

In another embodiment, the server computing system 130 may include or store at least one machine learning model 140 to perform one or more operations through the machine learning model 140, and may provide a service for providing a spatio-temporal preservation transformer to an user in conjunction with the user computing device 110 by communicating relevant data with the user computing device 110.

For example, the server computing system 130 provides an output for a user's input by using the machine learning model 140 via the web, and the user computing device 110 may perform the service for providing the spatio-temporal preservation transformer by accessing the web.

When implementing the artificial intelligence model, at least a part of the machine learning models 120 and/or 140 may be executed on the user computing device 110, while the remaining part of the machine learning models 120 and/or 140 is executed on the server computing system 130.

In addition, the user computing device 110 may include at least one input component 121 configured to receive or sense a user's input. For example, the user input component 121 may include a touch sensor (e.g., a touch screen and a touch pad) configured to detect a touch of an input medium (e.g., a finger and a stylus) of the user, an image sensor configured to detect a motion input of the user, a microphone configured to sense a user's voice input, a button, a mouse, and/or a keyboard, and the like. In the case of receiving an input to an external controller (e.g., a mouse, a keyboard, etc.) through an interface, the user input component 121 may include the interface and the external controller.

The server computing system 130 includes at least one processor 131 and memory 132. For example, the processor 131 may include one or more of a central processing unit (CPU), a graphic processing unit (GPU), application specific integrated circuits (ASICs), digital signal processors (DSPs), digital signal processing devices (DSPDs), programmable logic devices (PLDs), field programmable gate arrays (FPGAs), controllers, micro-controllers, microprocessors, and/or other types of electrical units for performing functions, or a plurality of electrically or communicationally connected processors.

The memory 132 may include one or more non-transitory and/or transitory computer readable storage media such as RAM, ROM, EEPROM, EPROM, flash memory devices, magnetic disks, etc., and combinations thereof. The memory 132 may store data 133 and instructions 134 which can be retrieved or executed by the processor 131 to perform functions or operations such as training an artificial intelligence model or estimating the 3D human pose and shape through the artificial intelligence model.

In an embodiment, the server computing system 130 may be configured to include at least one computing device or computer. For example, the server computing system 130 may be implemented to operate the plurality of computing devices according to a sequential computing architecture, a parallel computing architecture, or combination thereof. In addition, the server computing system 130 may include a plurality of computing devices connected to the network 170.

The server computing system 130 may also store at least one machine learning model 140. For example, the server computing system 130 may include a neural network and/or other multi-layer non-linear models as the machine learning model 140. An example of the neural network may include a feed forward neural network, a deep neural network, a recurrent neural network, and a convolution neural network.

The training computing system 150 includes at least one processor 151 and memory 152. For example, the processor 151 may include one or more of a central processing unit (CPU), a graphic processing unit (GPU), application specific integrated circuits (ASICs), digital signal processors (DSPs), digital signal processing devices (DSPDs), programmable logic devices (PLDs), field programmable gate arrays (FPGAs), controllers, micro-controllers, microprocessors, and/or other electrical units for performing functions, or a plurality of electrically or communicationally connected processors.

The memory 152 may include one or more non-transitory and/or transitory computer readable storage media such as RAM, ROM, EEPROM, EPROM, flash memory devices, magnetic disks, and the like, and combinations thereof. The memory 152 may store data 153 and instructions 154 which can be retrieved or executed by the processor 151 to perform training of the artificial intelligence model.

For example, the training computing system 150 may include a model trainer 160 configured to train the machine learning models 120 and/or 140 stored in the user computing device 110 and/or the server computing system 130 using various training or learning techniques such as backpropagation of errors.

In one example, the model trainer 160 may perform updates of one or more parameters of the machine learning models 120 and/or 140 in a backpropagation manner based on a defined loss function.

In some implementations, the performing of the backpropagation of the error may include performing truncated backpropagation through time. The model trainer 160 may perform several generalization techniques (e.g., weight reduction, drop out, and/or knowledge distillation, etc.) to improve the generalization capability of the trained machine learning model 120 and/or 140.

In particular, the model trainer 160 may train the machine learning model 120 and/or 140 based on training data 161. In this regard, the training data 161 may include different formats of data, such as, for example, images, audio samples, and/or text, etc. Examples of types of images that may be included in the training data 161 may include video frames, LiDAR point clouds, X-ray images, computed tomography scans, hyperspectral images, and/or various other forms of images.

The training data 161 may be provided from the user computing device 110 and/or the server computing system 130. When the training computing device 150 trains the machine learning model 120 and/or 140 based on specific data of the user computing device 110, the machine learning model 120 and/or 140 may be characterized as a personalized model.

The model trainer 160 includes a computer logic utilized to provide desired or necessary functionality.

In addition, the model trainer 160 may be implemented using hardware, firmware, and/or software that controls a general-purpose processor. In one implementation, the model trainer 160 includes a program file stored in a storage device, and may be loaded into the memory 152 and executed by one or more processors 151. In another implementation, the model trainer 160 includes one or more sets of computer-executable data 153 and instructions 154 stored in a tangible computer-readable storage medium, such as a RAM hard disk or optical or magnetic medium.

The network 170 may include, for example, but not limited to, a 3rd Generation Partnership Project (3GPP) network, a long term evolution (LTE) network, a world interoperability for microwave access (WIMAX) network, the Internet, a local area network (LAN), a wireless local area network (Wireless LAN), a wide area network (WAN), a personal area network (PAN), a Bluetooth network, a satellite broadcasting network, an analog broadcasting network, and/or a digital multimedia broadcasting (DMB) network.

In general, communication over the network 170 may be performed using any type of wired and/or wireless connection, and via various communication protocols (e.g., TCP/IP, HTTP, SMTP, and/or FTP, etc.), encoding or formats (e.g., HTML and/or XML, etc.), and/or a protection schema (e.g., VPN, secure HTTP, and/or SSL, etc.).

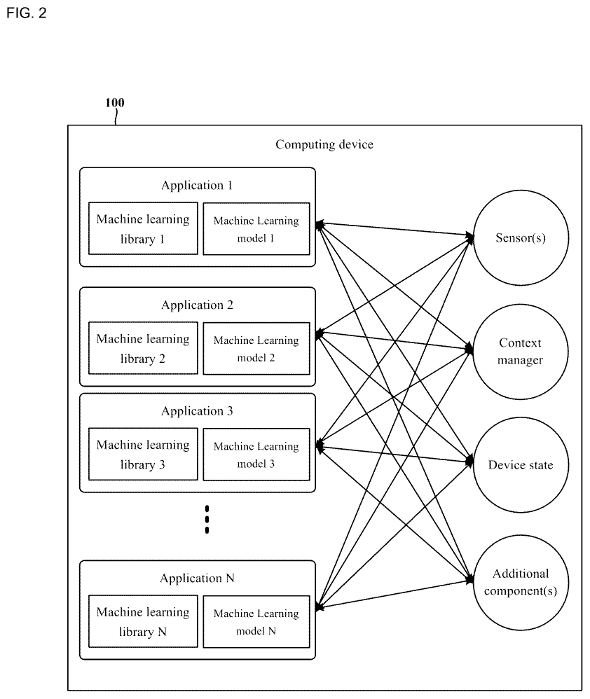

FIG. 2 illustrates a block diagram of a computing device for implementing a service for providing a spatio-temporal preservation transformer according to an embodiment of the present disclosure.

Referring to FIG. 2, the computing device 100, which may be included in each of the user computing device 110, the server computing system 130, and the training computing system 150 includes multiple applications (e.g., Applications 1 to N). Each application may include a machine learning library and one or more machine learning models. For example, the application may include an application for image processing (e.g., detection, classification, and/or segmentation, etc.), a text messaging application, an email application, a dictation application, a virtual keyboard application, a browser application, and/or a chat-bot application, etc.

In an embodiment, the computing device 100 may include the model trainer 160 for training the artificial intelligence model, and may store and operate the trained artificial intelligence model to provide output data according to predetermined input data (e.g., image sequence, etc.).

For example, each of the applications of the computing device 100 may communicate with other components of the computing device 100, such as one or more sensors, context managers, device status components, and/or additional components. In an embodiment, each application may communicate with each device component using an Application Programming Interface (API) (e.g., a public API). In an embodiment, the API used by each application may be specific to a corresponding application.

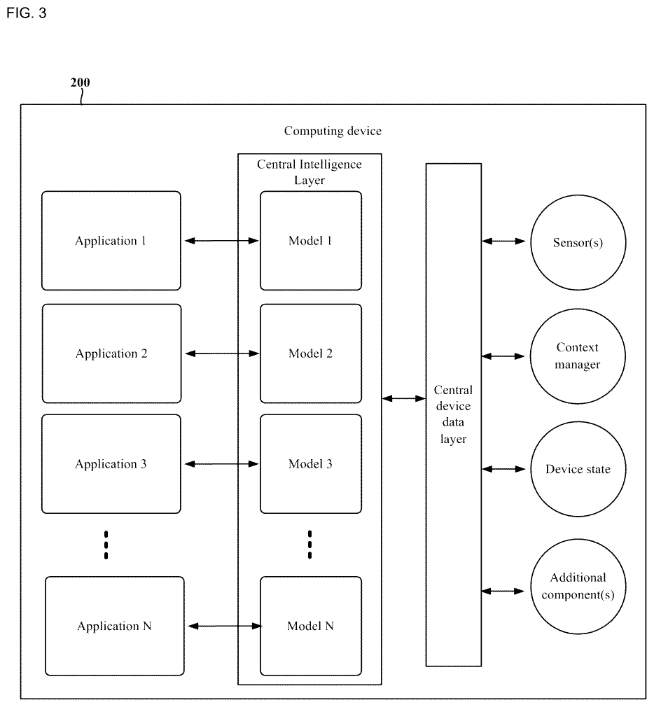

FIG. 3 illustrates a block diagram of a computing device 100 for implementing a service for providing a spatio-temporal preservation transformer according to an embodiment of the present disclosure.

Referring to FIG. 3, a computing device 200 includes multiple applications (e.g., Applications 1 to N). Each application may communicate with a central intelligence layer. For example, the application may include an image processing application, a text message application, an email application, a dictation application, a virtual keyboard application, and/or a browser application, etc. In an embodiment, each application may communicate with the central intelligence layer (and a model stored therein) using an API (e.g., a common API across all applications).

The central intelligence layer may include multiple machine learning models. For example, as shown in FIG. 3, at least a part of each machine learning model may be provided for each application and managed by the central intelligence layer. In another implementation, two or more applications may share one single machine learning model. For example, in some implementations, the central intelligence layer may provide a single model for all or multiple applications. In some implementations, the central intelligence layer may be included in an operating system of the computing device 200 or may be otherwise implemented.

The central intelligence layer may communicate with a central device data layer. The central device data layer may be a centralized data store for the computing device 200. As shown in FIG. 3, the central device data layer may communicate with multiple other components of the computing device 200, such as one or more sensors, context managers, device status components, and/or additional components. In some implementations, the central device data layer may communicate with each device component using an API (e.g., a private API).

The technology described herein may refer to servers, databases, software applications, and other computer-based systems as well as taken actions and information transmitted to or from systems. It will be appreciated that inherent flexibility of computer-based systems allows for a wide range of possible configurations, combinations and division of work and functionality between and from components. For example, the processes, methods, or services described herein may be implemented using multiple devices or components that operate in a single device or component or combination. Databases and applications may be implemented in a single system or a distributed system across multiple systems. The distributed components may operate sequentially or in parallel.

### [USTT: Uncertainty-Based Spatio-Temporal Transformer)]

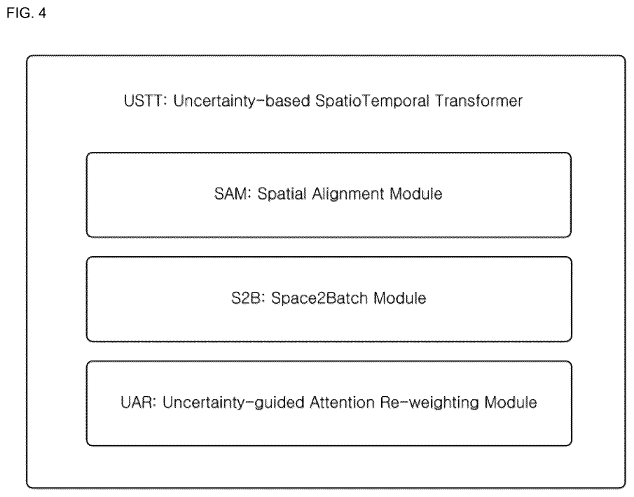

FIG. 4 illustrates a block diagram of an uncertainty-based spatio-temporal transformer according to an embodiment of the present disclosure.

Referring to FIG. 4, an uncertainty-based spatio-temporal transformer (USTT: hereinafter a “spatio-temporal transformer”) according to an embodiment of the present disclosure may be a data processing architecture that receives a predetermined image sequence as input and outputs information about a 3D human pose and shape according to the input image sequence.

Here, the transformer may be, for example, but not limited to, a model configured to process an input sequence based on a self attention mechanism.

The self attention may be, for instance, but not limited to, a mechanism that allows each element in an input sequence to learn the relationship with other elements in the input sequence.

The self attention may convert each token (Token) in the input sequence into three vectors, Query (Q), Key (K), and Value (V), compute an attention weight based on the similarity between Query (Q) and all Keys (K), calculate a weighted sum of Value (V) vectors using the computed attention weight, and use the calculated weighted sum of the Value (V) vectors as the output of the self attention to provide a contextual representation for each element of the input sequence.

Thus, the transformer may effectively extract and integrate key information even from long sequence data, and may have high parallel processing capability and fast learning speed.

Depending on the situation, the transformer may process the input sequence based on multi-head self attention, which performs the self attention multiple times in parallel.

Thus, the transformer may further improve its performance by integrating information from various aspects in different representation spaces to understand detailed information and an overall structure.

In an embodiment, the spatio-temporal transformer USTT may be an architecture that provides information about 3D human pose and shape according to a predetermined image sequence based on the self attention mechanism.

The spatio-temporal transformer USTT according to an embodiment of the present disclosure may be implemented as an efficient framework that considers both spatial and temporal dimensions and reduces or minimizes computational complexity, when estimating a 3D human pose and shape from a predetermined image sequence input such as the video.

For example, the spatio-temporal transformer USTT according to an embodiment of the present disclosure may include at least one of spatial alignment module (SAM), space2batch module (S2B), and/or an uncertainty-guided attention re-weighting module UAR.

The spatial alignment module (SAM) according to an embodiment may be a module (e.g., a software module) configured to spatially re-align adjacent frames with respect to a plurality of frames included in the predetermined input sequence.

In an embodiment, the spatial alignment module (SAM) may spatially align the feature of each adjacent frame to a central frame or a reference frame.

For example, the spatial alignment module (SAM) may calculate the visual similarity between a current frame feature and a adjacent frame feature using a dot product operation, and predict an affine transformation matrix through two subsequent fully connected layers. In this case, since rotation or shear transformation rarely occurs in a bounding box of a real video sequence, the affine transformation matrix may include scale and translation parameters along the x and y axes.

The space2batch module (S2B) according to an embodiment may be a module (e.g., a software module) configured to implement the spatio-temporal attention by decomposing spatial relationships and temporal relationships when performing an attention mechanism (hereinafter “spatio-temporal attention”) that considers both spatial and temporal dimensions.

In an embodiment, the space2batch module (S2B) may decompose temporal correlations from the spatial locations of the frame features, and thus perform the spatial-temporal attention by calculating only attention between identical spatial locations.

In an embodiment, the spatio-temporal transformer USTT may reduce the complexity of the spatio-temporal attention through the space alignment module (SAM) and the space2batch module (S2B).

The uncertainty-guided attention re-weighting module UAR according to an embodiment may be a module (e.g., a software module) configured to provide an uncertainty map which is a feature map that readjusts weights according to spatial-temporal attention in a predetermined manner.

In an embodiment, the spatio-temporal transformer USTT can improve the robustness of the model even in environments where motion blur and/or occlusion are present by the uncertainty-guided attention re-weighting module UAR.

Further, the spatio-temporal transformer USTT can identify a region where assistance from a surrounding frame (i.e., an adjacent frame) is needed when the 3D human pose and shape are predicted based on the current frame (i.e., a central frame), and can prevent errors in a specific frame from propagating to other frames.

The spatial alignment module (SAM), the space2batch module (S2B), and the uncertainty-guided attention re-weighting module UAR included in the spatio-temporal transformer USTT in an embodiment of the present disclosure will be described in detail in exemplary embodiments of a method for providing a spatio-temporal preservation transformer for 3D human pose and shape estimation, which will be described below.

In an embodiment illustrated in FIG. 4, in order to prevent the features from being blurred, the spatio-temporal transformer USTT is described as including the components described above. However, according to some embodiments of the present disclosure, one or more components other than those illustrated in FIG. 4 may be additionally included as general-purpose components, or one or some of the components shown in FIG. 4 may be omitted.

### [Method for Providing a Service for Providing a Spatio-Temporal Preservation Transformer]

Hereinafter, a method for implementing a service for providing a spatio-temporal preservation transformer that considers both spatial and temporal dimensions and reduces or minimizes computational complexity, when estimating the 3D human pose and shape based on an image sequence, such as a video, by the computing system 1000 according to an embodiment of the present disclosure will be described in detail.

The method for providing a service for a spatio-temporal preservation transformer for the 3D human pose and shape estimation, performed by the computing system 1000, according to an embodiment of the present disclosure can provide information about a 3D human pose and shape based on a continuous image sequence including a given human object with improved data processing efficiency and performance using the spatio-temporal transformer USTT.

Thereby, the method for providing the spatio-temporal preservation transformer for the 3D human pose and shape estimation, performed by the computing system 1000, according to an embodiment of the present disclosure can improve the quality of various application services and industrial environments that utilize the provided information about 3D human pose and shape.

The method for providing the spatio-temporal preservation transformer for the 3D human pose and shape estimation, performed by the computing system 1000, according to an embodiment of the present disclosure can estimate a 3D human pose and shape by taking into account error uncertainty within the image sequence, thereby further improving accuracy and reliability.

The method for providing the spatio-temporal preservation transformer for the 3D human pose and shape estimation according to an embodiment of the present disclosure will be described below in detail with reference to the accompanying drawings.

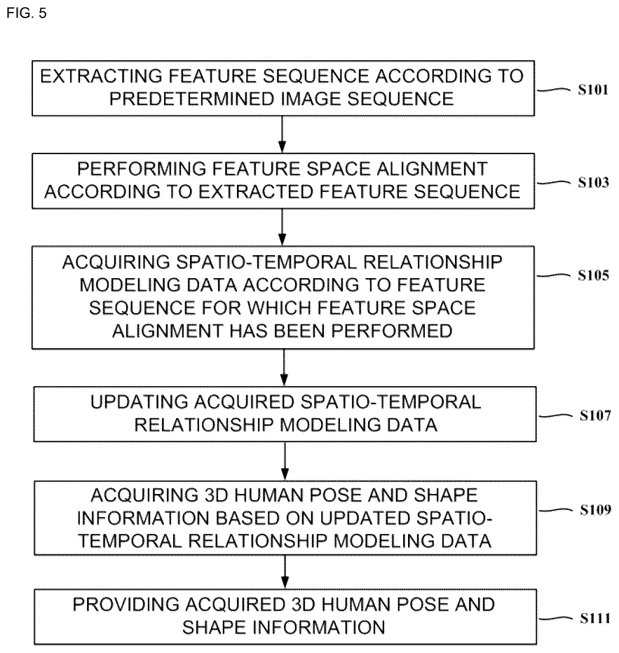

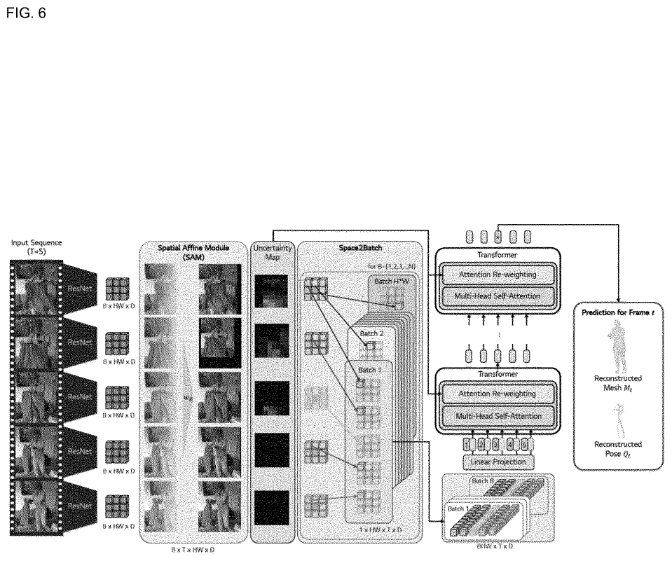

FIG. 5 is a flowchart illustrating a method for providing a spatio-temporal preservation transformer for 3D human pose and shape estimation according to an embodiment of the present disclosure, and FIG. 6 illustrates a conceptual diagram for illustrating a method for providing a spatio-temporal preservation transformer for 3D human pose and shape estimation according to an embodiment of the present disclosure.

Referring to FIGS. 5 and 6, a method for providing a spatio-temporal preservation transformer for 3D human pose and shape estimation according to an embodiment of the present disclosure may include step S101 of extracting a feature sequence according to a predetermined image sequence, step S103 of performing feature space alignment according to the extracted feature sequence, step S105 of acquiring spatio-temporal relationship modeling data according to a feature sequence for which feature space alignment has been performed, step S107 of updating the acquired spatio-temporal relationship modeling data, step S109 of acquiring information about a 3D human pose and shape based on the updated spatio-temporal relationship modeling data, and step S111 of providing the acquired information about the 3D human pose and shape.

At step S101, the computing system 1000 according to an embodiment of the present disclosure may extract a feature sequence according to a predetermined image sequence.

Here, the feature sequence according to an embodiment may be a set of features corresponding to each of a plurality of frames included in a predetermined image sequence.

In an embodiment, the computing system 1000 may detect a bounding box (hereinafter a “person bounding box”) including a human object from each of a plurality of frames included in the predetermined image sequence (hereinafter, a “target image sequence”).

For example, the plurality of frames may include a predetermined central frame, a preceding frame which is a frame before the central frame, and/or a succeeding frame which is a frame after the central frame.

Further, in an embodiment, the computing system 1000 may extract a feature from each image including a detected human bounding box region (hereinafter a “bounding box image”).

Thus, in an embodiment, the computing system 1000 may acquire the feature sequence based on the features extracted from each bounding box image.

In an embodiment, the computing system 1000 may extract and acquire the feature sequence in a form that maintains the spatial dimension without performing pooling on the feature in order to prevent loss of spatial information, while conventional image sequence-based data processing methods use a global average pooled vector.

At step S103, the computing system 1000 may perform feature space alignment according to the extracted feature sequence.

In detail, according to an embodiment, the computing system 1000 may perform a feature space alignment process for a feature sequence that maintains spatial dimension information as described above.

Here, the feature space alignment process according to an embodiment may be a process of spatially re-aligning features of adjacent frames with respect to a plurality of frames corresponding to a feature sequence including spatial dimension information.

In more detail, in an embodiment, the computing system 1000 may perform the feature space alignment based on the feature sequence in conjunction with the spatial alignment module (SAM).

Specifically, the computing system 1000 may spatially align features of each adjacent frame (e.g., the preceding frame and/or succeeding frame, etc.) corresponding to the feature sequence to features of the central frame or the reference frame.

That is, the computing system 1000 may spatially align the spatial locations of features within the temporal axis with respect to the features of the central frame.

In an embodiment, the spatial alignment module (SAM) may input features of each adjacent frame (hereinafter “adjacent frame features”) and features of the central frame (hereinafter “central frame features”), and output features (hereinafter “warping transformation features”) that warp the input adjacent frame features so that the adjacent frame features can be spatially aligned with the central frame features.

To this end, in an embodiment, the spatial alignment module (SAM) may predict an affine transformation matrix based on the adjacent frame features and center frame features.

Here, for reference, the affine transformation matrix according to an embodiment may include scale and translation parameters along the x-axis and y-axis.

For example, the Affine Transformation Matrix may be typically expressed as a 2*3 matrix as shown in Equation 1.

$$[ \begin{matrix}a & b & c \\ d & e & f\end{matrix} ] \qquad [ Equation 1 ]$$

Here, ‘a’ and ‘b’ may specify rotation and scaling, ‘c’ and ‘f’ may specify translation, and ‘d’ and ‘e’ may specify shear.

In detail, according to an embodiment, the spatial alignment module (SAM) may extract feature points of each of the adjacent frame features and the central frame features, and match extracted feature point pairs based on a predetermined method (e.g., BFMatcher and/or FLANN algorithm, etc.).

Further, in an embodiment, the spatial alignment module (SAM) may estimate the affine transformation matrix according to a predetermined method (e.g., a robust estimation method such as ANSAC and/or LMedS) based on the matched feature point pairs.

For example, the spatial alignment module (SAM) may predict the Affine Transformation Matrix by constructing a linear system based on the matched feature point pairs and solving the linear system to derive the transformation parameters a, b, c, d, e, and f.

Further, in an embodiment, the spatial alignment module (SAM) may generate the warping transformation feature based on the predicted Affine Transformation Matrix.

For instance, the spatial alignment module (SAM) may acquire the warping transformation feature using Equation 2 based on the predicted Affine Transformation Matrix.

$$( s , {t}_{x} , {t}_{y} ) = {g}_{θ} ( {X}_{t} , {X}_{t + δ} ) , A = [ \begin{matrix}s & 0 & {t}_{x} \\ 0 & s & {t}_{y}\end{matrix} ] \qquad [ Equation 2 ]$$

Further, in an embodiment, the spatial alignment module (SAM) may provide the acquired warping transformation feature to the computing system 1000.

Thereby, in an embodiment, the computing system 1000 may obtain a feature (i.e., the warping transformation feature) by warping each adjacent frame feature to be spatially aligned with the central frame feature through the feature spatial alignment.

In other words, the computing system 1000 may obtain the feature sequence (hereinafter a “feature spatial alignment sequence”) spatially aligned according to the warping transformation feature by the spatial alignment module (SAM).

At step S105, the computing system 1000 may obtain spatio-temporal relationship modeling data based on the feature sequence on which feature space alignment has been performed.

In an embodiment, the computing system 1000 may obtain the spatio-temporal relationship modeling data based on the feature spatial alignment sequence obtained as described above.

Here, the spatio-temporal relationship modeling data according to an embodiment may be, for example, but not limited to, data that models the spatio-temporal correlation between frames corresponding to the feature sequence using the transformer architecture based on the spatially aligned feature sequence (i.e., the feature spatial alignment sequence).

In other words, in an embodiment, the spatio-temporal relationship modeling data may be data that models the spatio-temporal correlation between features of adjacent frames using the transformer architecture, with respect to the plurality of frames corresponding to the feature spatial alignment sequence.

That is, the spatio-temporal relationship modeling data may be data that models the spatio-temporal correlation between feature spatial alignment sequences according to a predetermined weight, based on the self attention mechanism which is a core element of the transformer architecture.

The computational complexity of self attention (hereinafter, attention complexity) may generally depend on the length L of the input sequence and the dimension D of each token vector, and can be expressed with the complexity of O(L²×D).

This may mean that as the dimension of the input vector increases, the required computation (i.e., attention complexity) increases, and as the length of the sequence increases, the required computation (i.e., attention complexity) increases quadratically.

In an embodiment, for self attention that receives, as input, the feature spatial alignment sequence containing all spatio-temporal Information, the attention complexity, which increases with the square of the input dimension, can be expressed as O(dw²h²T²).

As such, when attention for each point is computed across the spatial-temporal axis, it may lead to excessive computational complexity as well as over-convergence. Therefore, to avoid this issue, in an embodiment, the computing system 1000 may obtain the spatio-temporal relationship modeling data in conjunction with the space2batch module (S2B).

Here, the space2batch module (S2B) according to an embodiment may be, for instance, but not limited to, a module that implements spatio-temporal attention by decomposing spatial and temporal relationships when performing the attention mechanism that considers both spatial and temporal dimensions (i.e., spatio-temporal attention).

In an embodiment, the space2batch module (S2B) may decompose temporal correlations from the spatial locations of features according to the feature spatial alignment sequence, and thus perform spatial-temporal attention by calculating only attention between identical spatial locations.

Specifically, in an embodiment, the space2batch module (S2B) may perform self attention by processing the feature spatial alignment sequence in which the spatial locations of features within the temporal axis are spatially aligned to the central frame features by the spatial alignment module (SAM), as a batch of the spatial dimension.

In this case, according to an embodiment, the space2batch module (S2B) may perform a multi-head self attention by processing the feature spatial alignment sequence as the space dimension batch.

Thus, in an embodiment, the space2batch module (S2B) may decompose the temporal correlation from the spatial locations of features according to the feature spatial alignment sequence, and implement space-time attention that calculates only attention between identical spatial locations.

To this end, the space2batch module (S2B) may reconstruct the feature sequence of a form (b, t, hw, d) into a form (bhw,t,d). By treating the spatial dimension (h×w) as the batch dimension and performing the attention operation only on the temporal axis (T), the space2batch module (S2B) can significantly reduce the existing computational complexity.

Referring to FIG. 6, in an embodiment, the space2batch module (S2B) may generate the spatio-temporal relationship modeling data in which the feature dimension is reconstructed from (b,t,hw,d) to (bhw,t,d).

Further, in an embodiment, the space2batch module (S2B) may provide the spatio-temporal relationship modeling data to the computing system 1000.

Thereby, in an embodiment, the computing system 1000 may obtain spatio-temporal relationship modeling data of the above-described type, which models spatio-temporal correlations between feature spatial alignment sequences based on the self attention mechanism from the space2batch module (S2B).

As such, in an embodiment, the computing system 1000 may obtain the spatio-temporal relationship modeling data by using the spatio-temporal transformer USTT that performs space-time attention considering both spatial and temporal dimensions while reducing the computational complexity (i.e., attention complexity) from O(dw²h²r²) to O(dwhT²).

Accordingly, in an embodiment, the computing system 1000 may implement the transformer (i.e., the spatio-temporal transformer USTT) that implements faster and more efficient data processing compared to conventional methods that perform full spatio-temporal attention, and may use the transformer to obtain base data (i.e., spatio-temporal relationship modeling data) for estimating 3D human pose and shape information within a predetermined image sequence.

Therefore, the computing system 1000 can improve the data processing efficiency and performance required when the information about the 3D human pose and shape information is estimated based on a predetermined image sequence, and can enhance the quality of the information of the 3D human pose and shape provided based thereon.

In addition, in an embodiment, the computing system 1000 can effectively improve performance in terms of reconstruction error by performing correlation modeling that considers both space and time without compressing spatial information as in the conventional method.

At step S107, the computing system 1000 may update the acquired spatio-temporal relationship modeling data.

In an embodiment, the computing system 1000 may update the spatio-temporal relationship modeling data acquired as described above in conjunction with an uncertainty-guided attention re-weighting module UAR to adjust the spatio-temporal relationship modeling data.

In detail, it needs to prevent errors in a specific frame from propagating throughout the entire sequence when modeling the spatio-temporal correlations.

This should be taken into account especially in a case where incorrect predictions may occur due to the presence of motion blur and/or occlusion in some frames within the image sequence, such as a video.

However, in the conventional method, there is a high possibility of error propagation because the temporal relationship is simply modeled using a transformer.

Therefore, in order to avoid this problem of the conventional method, according to an embodiment, the computing system 1000 may update the spatio-temporal relationship modeling data in conjunction with the uncertainty-guided attention re-weighting module UAR to adjust the spatio-temporal relationship modeling data.

Here, the uncertainty-guided attention re-weighting module UAR according to an embodiment may be, for example, but not limited to, a module (e.g. a software module) configured to provide an uncertainty map which is a feature map that readjusts weights according to spatial-temporal attention.

Specifically, in an embodiment, the computing system 1000 may input the feature spatial alignment sequence into the uncertainty-guided attention re-weighting module UAR.

In this way, in an embodiment, the uncertainty-guided attention re-weighting module UAR may generate a predicted uncertainty map U based on the input feature spatial alignment sequence.

The uncertainty-guided attention re-weighting module UAR may estimate uncertainty (e.g., the possibility of the presence of a specific noise) for the input feature spatial alignment sequence and generate the uncertainty map U that specifies the uncertainty.

Further, in an embodiment, the uncertainty-guided attention re-weighting module UAR may adjust the attention weight for the spatio-temporal relationship modeling data using Equation 3 based on the generated uncertainty map U.

$$Attention ( Q , K , V ) = softmax ( \frac{Q {K}^{T}}{\sqrt{d}} - γ U ) V , \qquad [ Equation 3 ]$$

Thereby, in an embodiment, the uncertainty-guided attention re-weighting module UAR may obtain spatio-temporal relationship modeling data (hereinafter “spatio-temporal relationship update data”) with the attention weight adjusted or updated according to the uncertainty map U.

Further, in an embodiment, the uncertainty-guided attention re-weighting module UAR may provide acquired spatio-temporal relationship update data to the computing system 1000.

Thereby, in an embodiment, the computing system 1000 may obtain spatio-temporal relationship modeling data (i.e., spatio-temporal relationship update data) adjusted to reflect the estimated uncertainty for the feature spatial alignment sequence.

Accordingly, in an embodiment, the computing system 1000 may train the uncertainty-guided attention reweighting module UAR to predict and generate the uncertainty map U.

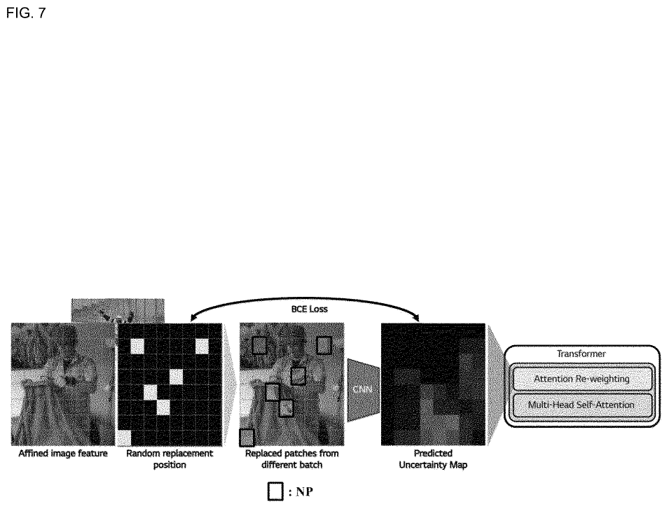

FIG. 7 illustrates a conceptual diagram for illustrating a learning method of an uncertainty-guided attention re-weighting module UAR according to an embodiment of the present disclosure.

Referring to FIG. 7, according to an embodiment, the computing system 1000 may generate an artificial artifact that is intentionally synthesized by randomly replacing at least a portion of the above-described spatial dimension batch with noise patches NP of spatial-temporal locations according to any other image sequences.

Further, in an embodiment, the computing system 1000 may train a small-scale network to distinguish generated artificial artifacts (hereinafter, “uncertainty learning artifacts”).

That is, the computing system 1000 may perform small-scale network training to identify uncertainty learning artifacts that interfere with single-frame-based prediction.

Here, the computing system 1000 may train the uncertainty values of randomly replaced patches (e.g., noise patches NP) to be ‘1’ through Binary Cross-Entropy (BCE) loss, and train the uncertainty values of other patches to be ‘0’.

The computing system 1000 may train the small-scale network using BCE loss by setting the uncertainty values of the randomly replaced noise patches NP to ‘1’ and the uncertainty values of the other patches to ‘0’.

According to an embodiment, the small-scale network may be included in and operated by the uncertainty-guided attention reweighting module UAR, or may be implemented as a separate device and/or server from the uncertainty-guided attention reweighting module UAR and operated in association with the uncertainty-guided attention re-weighting module UAR.

In the following description, the small-scale network is described as being implemented as part of the uncertainty-guided attention re-weighting module UAR for illustration purposes only, but the present disclosure is not limited thereto.

Thereby, in an embodiment, the computing system 1000 may build the uncertainty-guided attention re-weighting module UAR that predicts uncertainty for the input feature spatial alignment sequence and generates the uncertainty map U that specifies the uncertainty.

Accordingly, the computing system 1000 may train the uncertainty-guided attention re-weighting module UAR according to an embodiment described above to identify errors (e.g., noise) within a specific frame, obtain the uncertainty map U that predicts errors within the feature spatial alignment sequence using the trained UAR, and adjust the attention weight of the spatio-temporal relationship modeling data for the feature spatial alignment sequence by applying the obtained uncertainty map U.

Through this, in an embodiment, the computing system 1000 may implement the spatio-temporal transformer USTT that accurately estimates information about the 3D human pose and shape from the image sequence even when errors such as motion blur and/or occlusion are present in some frames of the image sequence.

In addition, the computing system 1000 can easily identify a region where assistance from a surrounding frame (i.e., adjacent frame) is needed when predicting the 3D human pose and shape for the current frame (i.e., central frame), and can prevent the propagation of errors from a specific frame to other frames in advance.

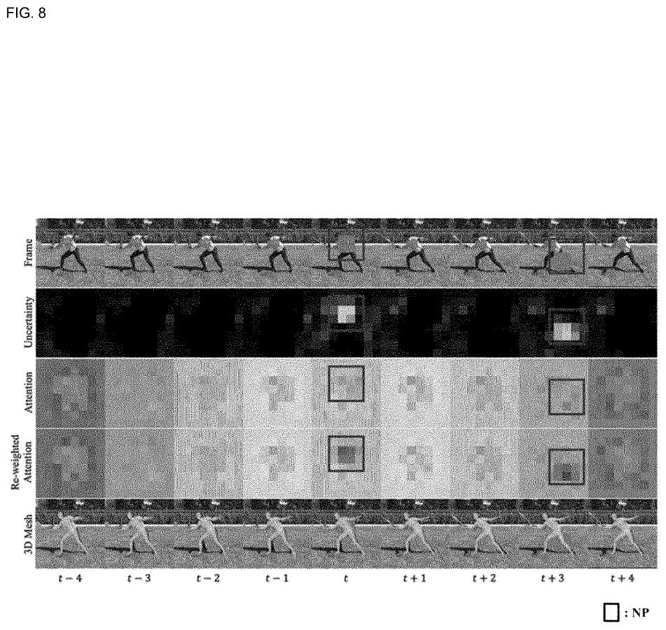

FIG. 8 illustrates an example for visualizing a data processing method for a method for providing a spatio-temporal preservation transformer according to an embodiment of the present disclosure.

Referring to FIG. 8, as the computing system 1000 performs the process described above according to an embodiment, exemplary visualizations of the uncertainty map U, attention weights, the adjusted attention weights, and the information about the 3D human pose and shape are provided when a predetermined noise patch NP is added to specific frames.

At the second row of FIG. 8, the uncertainty values for the occluded noise patch NP regions in the first row of FIG. 8 are predicted with high accuracy. Additionally, the predicted uncertainty map U may be used to re-adjust the attention map (i.e., attention weight) from the third row of FIG. 8 to the fourth row of FIG. 8.

At step S109, the computing system 1000 may acquire the information about the 3D human pose and shape according to the updated spatio-temporal relationship modeling data.

In an embodiment, the computing system 1000 may acquire the information about the 3D human pose and shape according to the target image sequence based on the spatio-temporal relationship update data.

In other words, the computing system 1000 may acquire 3D human pose and shape information related to a human object included in a target image sequence by reflecting spatio-temporal relationship update data.

In detail, according to an embodiment, the computing system 1000 may acquire the 3D human pose and shape Information based on the SMPL (Skinned Multi-Person Linear model).

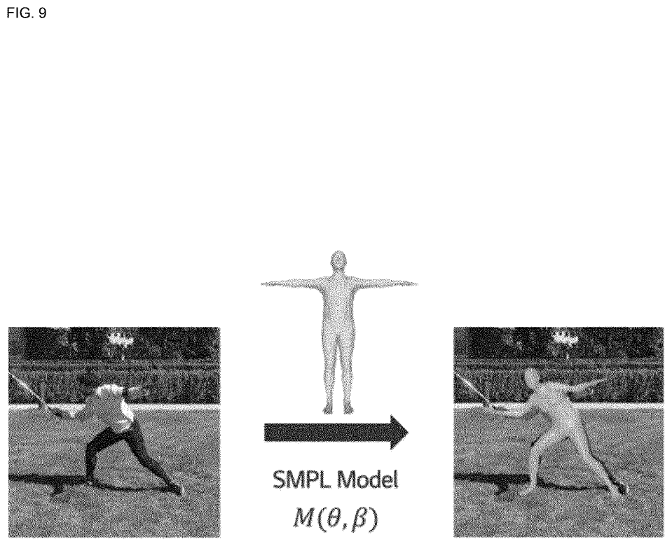

FIG. 9 illustrates a conceptual diagram for illustrating a Skinned Multi-Person Linear (SMPL) for 3D human pose and shape estimation according to an embodiment of the present disclosure.

Referring to FIG. 9, the SMPL may be, for example, but not limited to, a model that represents a human pose and shape in a 3D parameterized form.

In other words, the SMPL may be a model that expresses various poses and body types using a simple set of parameters that may mathematically represent the 3D human pose and shape.

The SMPL may provide information about the 3D human pose and shape that implements smooth and continuous surface deformation according to a Blend Skinning technique.

Thus, the SMPL may support the efficient generation, verification, and modification of the 3D human pose and shape, and may naturally simulate diverse and complex poses and shape changes.

Hereinafter, an example of the construction of the SMPL will be described in detail.

In an embodiment, the computing system 1000 may predict pose parameters θ and shape parameters β for estimating a 3D human pose and shape according to a target image sequence based on the SMPL.

The computing system 1000 may predict the pose parameters θ and the shape parameters β by reflecting the attention weight according to the spatio-temporal relationship update data.

Thereby, in an embodiment, the computing system 1000 may obtain information about a predicted 3D human pose and shape based on attention weights according to spatio-temporal relationship update data on the human object included in the target image sequence.

At step S111, the computing system 1000 may provide the acquired 3D human pose and shape Information.

In detail, according to an embodiment, the computing system 1000 may provide the information about the 3D human pose and shape acquired for the target image sequence as described above according to a predetermined method.

According to an embodiment, the computing system 1000 may provide the information about the 3D human pose and shape obtained according to an embodiment of the present disclosure in various ways in conjunction with a predetermined application service (e.g., 3D modeling service, virtual reality service, 3D gaming service, etc.).

Unlike conventional methods that perform full spatio-temporal attention, the computing system 1000 according to an embodiment may spatially align the input feature sequence to efficiently compute spatial-temporal relationships, and estimate a 3D human pose and shape about a predetermined central frame within the continuous image sequence using the spatio-temporal transformer USTT with enhanced robustness by adjusting attention weights based on uncertainty.

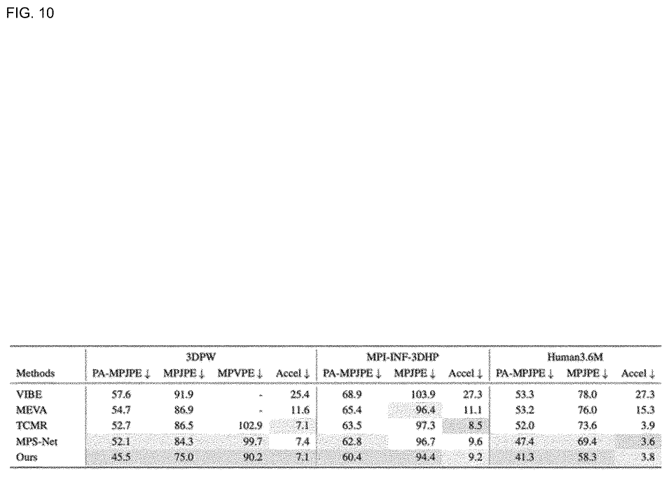

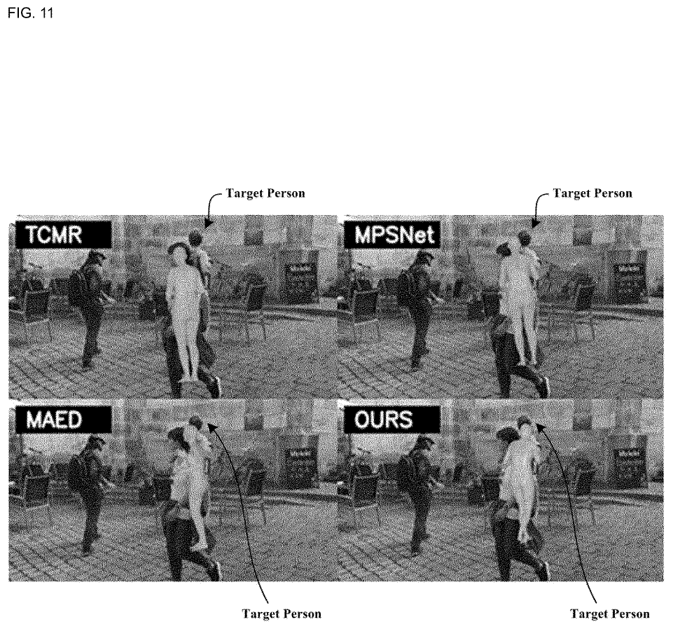

FIGS. 10 and 11 illustrate examples of comparing a performance difference between methodologies for estimating a 3D human pose and shape based on an image sequence according to an embodiment of the present disclosure and a conventional methodology.

Referring to FIG. 10, as a result of quantitative comparison with existing methodologies (e.g., 3DPW, MPI-INF-3DHP, and/or Human3.6M) in terms of reconstruction error (e.g., PA-MPJPE, MPJPE, and/or MPVPE) and temporal error (e.g., Acceleration), the performance of an embodiment of the present disclosure is significantly improved compared to conventional methods. In particular, the methodology performed according to the embodiment of the present disclosure shows a large performance difference in terms of reconstruction error, as it models temporal relationships without compressing spatial information.

To be more specific, for the 3DPW dataset, an embodiment of the present disclosure achieves a PA-MPJPE of 45.5 mm, demonstrating superior reconstruction accuracy compared to existing techniques such as MPS-Net (52.1 mm) and TCMR (52.7 mm). In addition, for the Human3.6M dataset, an embodiment of the present disclosure shows an MPJPE of 58.3 mm, providing outstanding performance compared to VIBE (78.0 mm) and TCMR (73.6 mm). These quantitative results demonstrate that an embodiment of the present disclosure improves reconstruction errors by reducing or minimizing the loss of spatial information.

Referring to FIG. 11, the prediction performance of an embodiment of the present disclosure is more robust and accurate than conventional methods even in specific situations where occlusion occurs.

As such, in an embodiment, the computing system 1000 provides an efficient framework specialized for 3D human pose and shape estimation based on continuous image sequences, thereby improving the quality of various application services and related industrial environments built upon it.

In an embodiment of the present disclosure, a pre-trained ResNet-34 model may be used as the backbone network for feature extraction, and the final global pooling layer of the model may be omitted to preserve the spatial information of the feature map. The dimensions of the extracted feature map X_t may be height h, width w, and depth d of 8, 8, and 512, respectively. The transformer for spatio-temporal relationship modeling may be composed of three encoder layers, and each layer may include eight multi-head attentions. During the model training, the Adam optimizer may be used, and the input images may be resized to a size of 256×256. As a training dataset, a mixture of Human3.6M, MPI-INF-3DHP, and 3DPW may be used.

As described above, a method and system for providing a spatio-temporal preservation transformer for 3D human pose and shape estimation according to an embodiment of the present disclosure may provide a transformer that considers both spatial and temporal dimensions and reduces or minimizes computational complexity, when estimating a 3D human pose and shape based on an image sequence, such as a video, thereby improving the data processing efficiency and performance required for the 3D human pose and shape estimation based on the image sequence, enhancing the quality of the resulting data itself and improving various application services and related industrial environments that utilize it.

Further, a method and system for providing a spatio-temporal preservation transformer for 3D human pose and shape estimation according to an embodiment of the present disclosure may provide a transformer that further considers error uncertainty within an image sequence, thereby estimating the 3D human pose and shape from the image sequence with high accuracy, even when a certain frame in the corresponding image sequence contains errors such as motion blur and/or occlusion.

Furthermore, a method and system for providing a spatio-temporal preservation transformer for 3D human pose and shape estimation according to an embodiment of the present disclosure can easily identify a region where assistance from a surrounding frame (i.e., a adjacent frame) is needed when the 3D human pose and shape for a current frame (i.e., a central frame) is predicted, and can prevent the propagation of errors from a specific frame to other frames in advance.

The embodiments according to the present disclosure described above may be implemented in the form of program instructions that may be executed through various computer components and recorded in a computer-readable recording medium. The computer-readable recording medium may include program instructions, data files, data structures, and the like alone or in combination with each other. The program instructions recorded in the computer-readable recording medium may be specially designed and configured for the present disclosure or may be known and available to those skilled in the field of computer software. Examples of computer-readable recording media include hardware devices specially configured to store therein and execute program instructions, such as magnetic media such as hard disks, floppy disks and magnetic tapes, optical recording media such as CD-ROM and DVD, magneto-optical media such as floptical disks, and ROM, RAM, flash memory, and the like. Examples of the program instructions include not only machine language codes such as those generated by the compiler, but also high-level language codes that may be executed by a computer using an interpreter or the like. The hardware device may be changed to one or more software modules to perform processing according to the present disclosure, and vice versa.

The specific executions described in the present disclosure are examples, and the scope of the present disclosure is not limited thereto in any manner. For the sake of brevity of the present disclosure, the description of conventional electronic configurations, control systems, software, and other functional aspects of the systems may be omitted. In addition, the connection or connection members of the lines between the components illustrated in the drawings exemplarily represent functional connections and/or physical or circuit connections, and may be represented as various alternative or additional functional connections, physical connections, or circuit connections in an actual device. In addition, if there is no specific mention such as “essential”, “important”, or the like, it may not be an essential component for the application of the present disclosure.

In addition, although the detailed description of the present disclosure has been made with reference to the preferred embodiments of the present disclosure, it will be understood that those skilled in the art or those skilled in the art can variously modify and change the present disclosure within the scope not departing from the spirit and technical areas of the present disclosure described in the claims to be described later. Therefore, the technical scope of the present disclosure is not limited to the contents described in the detailed description of the specification, but should be determined by the claims.

The mode for carrying out the present disclosure is the same as the best mode for carrying out the disclosure described above.

The present disclosure generally relates to a method and system for providing a spatio-temporal preservation transformer for 3D human pose and shape estimation, and is applicable to the artificial intelligence industry, and thus has industrial applicability.

What is claimed is:

1. A method for estimating a 3D human pose and shape from an image sequence, the method comprising:
acquiring the image sequence containing a plurality of frames;
acquiring a feature sequence by extracting a feature that maintains a spatial dimension from each of the plurality of frames of the image sequence;
by spatially aligning features of adjacent frames based on a feature of a reference frame within the acquired feature sequence, generating a spatial alignment feature sequence including the aligned features;
generating spatio-temporal correlation data by processing a spatial dimension of the spatial alignment feature sequence in a batch unit, and modeling a relationship between features along a temporal axis for each feature group within a same space across the plurality of frames of the image sequence; and
determining information about a pose and shape of a human object in the image sequence based on the spatio-temporal correlation data.

2. The method of claim 1, wherein the generating of the spatial alignment feature sequence comprises maintaining spatial Information and temporal Information without applying global average pooling to the feature sequence.

3. The method of claim 1, wherein the generating of the spatial alignment feature sequence comprises applying affine transformation to the features of the adjacent frames to spatially align the features.

4. The method of claim 3, wherein the affine transformation is determined by performing a dot product operation to compute visual similarity between the feature of the reference frame and the features of the adjacent frames, and inputting a result of performing the dot product operation into fully connected layers.

5. The method of claim 1, wherein the acquiring of the feature sequence comprises:
detecting a bounding box including an object within the image sequence; and
extracting the feature sequence from an image including a region of the detected bounding box.

6. The method of claim 1, wherein the generating of the spatio-temporal correlation data comprises generating the spatio-temporal correlation data based on an attention weight derived from a self attention mechanism according to a transformer architecture.

7. The method of claim 6, wherein the generating of the spatio-temporal correlation data further comprises generating an uncertainty map indicating a possibility of occurrence of an artifact within a frame of the plurality of frames from the spatial alignment feature sequence.

8. The method of claim 7, wherein the uncertainty map is generated by a neural network trained using a Binary Cross-Entropy (BCE) loss to identify a synthetic artifact generated by replacing a patch within the feature with a patch from another image sequence.

9. The method of claim 7, wherein the generating of the spatio-temporal correlation data further comprises:
generating an artificial artifact synthesized by randomly replacing at least a portion of a spatial dimension batch with a noise patch at a spatial-temporal location according to another image sequence, and
training a network to identify the generated artificial artifact.

10. The method of claim 7, wherein the generating of the spatio-temporal correlation data further comprises adjusting the attention weight of the spatio-temporal correlation data based on the generated uncertainty map.

11. The method of claim 10, wherein the determining of the information about the pose and shape of the human object in the image sequence comprises determining pose parameters and shape parameters for the human object based on a Skinned Multi-Person Linear (SMPL) model.

12. The method of claim 11, wherein the determining of the information of the pose and shape of the human object in the image sequence further comprises predicting the pose parameters and shape parameters for the human object by applying the attention weight adjusted based on the uncertainty map.

13. The method of claim 1, further comprising generating a three-dimensional (3D) human model based on the determined pose parameters and shape parameters for the human object.

14. The method of claim 13, further comprising providing a virtual fitting service by generating a composite view in which a 3D clothing model is fitted to the generated 3D human model and displaying the composite view on a display.

15. The method of claim 13, further comprising applying pose Information acquired from the 3D human model to a digital avatar, generating a video in which the digital avatar reproduces movement of the human object in the image sequence, and linking the video with a virtual reality service.
